(19) United States
(12) Patent Application Publication
(10) Pub. No.: US 2013/0071094 A1
(43) Pub. Date: Mar. 21, 2013

(54) CONTENT TRANSMISSION SYSTEM INCLUDING CONTENT RECORDING APPARATUS AND CONTENT PLAYBACK APPARATUS CONNECTED THROUGH WIRELESS TRANSMISSION PATH, CAPABLE OF RECORDING PROGRAM CONTENT AND SIMULTANEOUSLY PLAYING BACK PROGRAM CONTENT IN REAL TIME

(71) Applicant: PANASONIC CORPORATION, Osaka (JP)

(72) Inventors: Osamu TANAKA, Osaka (JP); Toyoshi YAMADA, Osaka (JP); Nobuhiko ARASHIN, Osaka (JP); Masahiko NAGOSHI, Osaka (JP); Akihiko SHIOTSUKI, Osaka (JP); Akira YAMASAKI, Osaka (JP)

(73) Assignee: PANASONIC CORPORATION, Osaka (JP)

(21) Appl. No.: 13/677,689

(22) Filed: Nov. 15, 2012

Related U.S. Application Data
(63) Continuation of application No. PCT/JP2012/002442, filed on Apr. 6, 2012.

(30) Foreign Application Priority Data
Apr. 14, 2011 (JP) 2011-089866

(51) Int. Cl. H04N 5/917

(52) U.S. Cl. CPC H04N 5/917
USPC 386/328

(57) ABSTRACT

A content recording apparatus comprising: an encoding unit for encoding program content at a data rate; a HDD for storing the encoded program content; a wireless transmitting and receiving unit for transmitting the encoded program content to a content playback apparatus; a data rate memory for storing the data rate at which the program content is encoded; and a data rate setting unit for setting the data rate stored in the data rate memory, on the encoding unit. The wireless transmitting and receiving unit receives result information from the content playback apparatus, the result information indicating whether or not the program content transmitted to the content playback apparatus has been correctly played back on the content playback apparatus. The data rate setting unit determines, based on the result information, a data rate at which the program content is encoded, and stores the data rate in the data rate memory.

### CROSS-REFERENCE TO RELATED APPLICATIONS

This is a continuation application of International Application No. PCT/JP2012/002442, with an international filing date of Apr. 6, 2012, which claims priority of Japanese Patent Application No. 2011-089866 filed on Apr. 14, 2011, the content of which is incorporated herein by reference.

### BACKGROUND

1. Technical Field

The technical field relates to a content recording apparatus in a content transmission system including the content recording apparatus and a content playback apparatus which are connected to each other through a wireless transmission path. The content recording apparatus records content including video and/or audio such as a TV program or a movie (hereinafter, referred to as “program content”), and transmits the recorded program content to the content playback apparatus through the wireless transmission path. The present disclosure also relates to a content recording method for such a content recording apparatus, and further relates to a content transmission system including such a content recording apparatus.

2. Description of Related Art

As data communication through networks such as the Internet and a LAN (Local Area Network) has been popularized, even at home, a home network capable of connecting home appliances, computers, and other peripheral devices through a network for device-to-device communication has been more commonly used. The home network makes it possible to transmit and receive content between devices connected to each other through a network, and provides convenient and comfortable user experiences. In addition, it is expected that network devices provided with a wireless connection function for connecting the devices to each other will be more popularized in future, due to flexibility in location for installing the device, and due to the advantage of eliminating a wiring between the devices to be connected to each other.

As an example of a home network including a wireless connection, there is a content transmission system in which a content recording apparatus, having content receiving means such as a TV tuner and content storage means such as a hard disk drive (HDD), is connected to a content playback apparatus, having content playback means such as a digital TV or a personal computer (PC), through a wireless transmission path. According to such a content transmission system, the content recording apparatus transmits program content stored on its hard disk drive, to the content playback apparatus through the wireless transmission path, and the content playback apparatus plays back the program content while receiving the program content, thus achieving so-called time-shift playback of the program content.

When the content recording apparatus transmits program content to the content playback apparatus through the wireless transmission path, such a problem arises that a transmission bandwidth becomes insufficient due to wireless nature, in particular, due to a long distance between the apparatuses, or due to an environment of locations at which the apparatuses are installed, resulting in the content playback apparatus being unable to correctly play back the video and/or audio of the program content.

In order to address this problem, for example, Patent Literature 1 proposes a method of providing both a content recording apparatus and a content playback apparatus, with a video recording apparatus, and storing, in advance, video content to be played back, in the video storage apparatus of the content playback apparatus. Patent Literature 1 further proposes a method of calculating a sufficient transmission rate for transmitting video content to be played back, down-converting the video content at the calculated rate, and transmitting the down-converted video content.

FIG. 15 is a block diagram showing a configuration of a conventional content transmission system. The content transmission system of FIG. 15 includes a content recording apparatus 101 and a content playback apparatus 102 which are connected to each other through a wireless transmission path 103. The content recording apparatus 101 records program content which is obtained from another apparatus (not shown), and transmits the program content to the content playback apparatus 102 through the wireless transmission path 103. The content playback apparatus 102 receives the program content from the content recording apparatus 101, and plays back the program content.

In the content recording apparatus 101, a content receiving unit 111 receives program content such as that in a TV broadcast in a format such as MPEG2. Then, a down-converting unit 112 calculates a transmission rate of the wireless transmission path 103 between the content recording apparatus 101 and the content playback apparatus 102, and encodes (down-converts) at the transmission rate the program content received by the content receiving unit 111. The program content encoded by the down-converting unit 112 is stored on an HDD 113, and is transmitted, by a wireless transmitting and receiving unit 114, to the content playback apparatus 102 through the wireless transmission path 103.

In the content playback apparatus 102, a wireless transmitting and receiving unit 121 receives the program content from the content recording apparatus 101 through the wireless transmission path 103. A decoding unit 122 processes the program content received by the wireless transmitting and receiving unit 121 for playback, and plays back the processed program content through a display 123 and a speaker 124.

According to the content transmission system of FIG. 15, when the data rate of program content encoded by the down-converting unit 112 exceeds the transmission rate of the wireless transmission path 103, the content recording apparatus 101 re-encodes, by the down-converting unit 112, the program content stored on the HDD 113, such that the data rate does not exceed the transmission rate, and transmits the re-encoded program content to the content playback apparatus 102. Thus, the content playback apparatus 102 can correctly play back the program content, without suffering from an insufficient bandwidth of the wireless transmission path 103.

### CITATION LIST

### Patent Literature

PATENT LITERATURE 1: Japanese Patent Laid-open Publication No. 2003-169299

### SUMMARY

### Technical Problem

However, the content transmission system of FIG. 15 requires the time to re-encode program content stored on the HDD 113, when a data rate of encoded program content exceeds the transmission rate of the wireless transmission path 103. Therefore, suppose that while the content recording apparatus 101 encodes program content at a transmission rate and stores the encoded program content on the HDD 113, the content playback apparatus 102 plays back the encoded program content in real time. In this case, if a situation occurs where the program content needs to be re-encoded, then the real-time playback of the program content is interrupted.

One non-limiting and exemplary embodiment is to provide a content recording apparatus capable of recording program content, and simultaneously transmitting the recorded program content to a content playback apparatus through a wireless transmission path, so that the content playback apparatus plays back the program content in real time. Another non-limiting and exemplary embodiment is to provide a content recording method for such a content recording apparatus, and a content transmission system including such a content recording apparatus.

### Solution to Problem

According to one aspect of the present disclosure, there is provided a content recording apparatus connected to a content playback apparatus through a wireless transmission path. The content recording apparatus is provided with: an encoding unit for encoding program content at a data rate; a program content storage for storing the encoded program content; a wireless transmitting and receiving unit for transmitting the encoded program content to the content playback apparatus; a data rate memory for storing the data rate at which the program content is encoded; and a data rate setting unit for setting the data rate stored in the data rate memory, on the encoding unit. The wireless transmitting and receiving unit receives result information from the content playback apparatus, the result information indicating whether or not the program content transmitted to the content playback apparatus has been correctly played back on the content playback apparatus. The data rate setting unit determines, based on the result information, a data rate at which the program content is encoded, and stores the data rate in the data rate memory.

These general and specific aspects may be implemented using a system, a method, and a computer program, and any combination of systems, methods, and computer programs.

### Advantageous Effects of Invention

According to the present disclosure, the data rate at which program content is encoded does not exceed the transmission rate of the wireless transmission path, thus preventing the necessity of re-encoding the program content. Therefore, it is possible to record program content, and simultaneously transmit the recorded program content to the content playback apparatus through the wireless transmission path, so that the content playback apparatus plays back the program content in real time.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF DRAWINGS

FIG. 1 is a block diagram showing a configuration of a content transmission system according to a first embodiment of the present disclosure.

FIG. 2 is a flowchart showing a program content transmission process performed by a content recording apparatus 1 of FIG. 1.

FIG. 3 is a flowchart showing a program content reception process performed by a content playback apparatus 2 of FIG. 1.

FIG. 4 is a flowchart showing a program content transmission process performed by a content recording apparatus 1 of a content transmission system according to a second embodiment of the present disclosure.

FIG. 5 is a flowchart showing an available data rate determination and program content transmission process performed by a content recording apparatus 1 of a content transmission system according to a third embodiment of the present disclosure.

FIG. 6 is a flowchart showing a subroutine of an available data rate determination process S33 of FIG. 5.

FIG. 7 is a diagram showing a state in which there is free space in a data rate table stored in a data rate memory 16 of the content recording apparatus 1 in the content transmission system according to the third embodiment of the present disclosure.

FIG. 8 is a diagram showing a state in which available/unavailable information is written in the data rate table stored in the data rate memory 16 of the content recording apparatus 1 in the content transmission system according to the third embodiment of the present disclosure.

FIG. 9 is a flowchart showing a subroutine of a program content transmission process S34 of FIG. 5.

FIG. 10 is a flowchart showing a subroutine of a program content transmission process S34 which is performed by a content recording apparatus 1 of a content transmission system according to a modified embodiment of the third embodiment of the present disclosure.

FIG. 11 is a block diagram showing a configuration of a content transmission system according to a fourth embodiment of the present disclosure.

FIG. 12 is a flowchart showing a program content transmission process performed by a content recording apparatus 1A of FIG. 11.

FIG. 13 is a diagram showing a first state of a data rate table stored in a data rate memory 16A of FIG. 11.

FIG. 14 is a diagram showing a second state of the data rate table stored in the data rate memory 16A of FIG. 11.

FIG. 15 is a block diagram showing a configuration of a conventional content transmission system.

### DETAILED DESCRIPTION

Embodiments of the present disclosure will be described below with reference to the drawings. In the drawings, the similar components are denoted by the same reference signs.

### First Embodiment

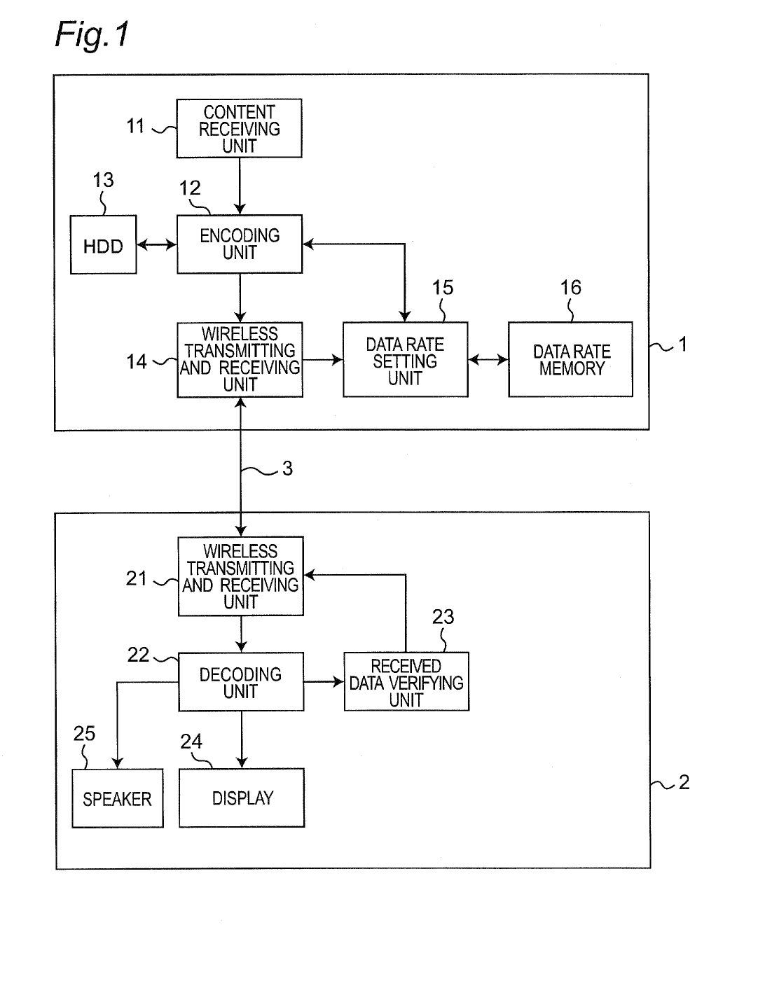

FIG. 1 is a block diagram showing a configuration of a content transmission system according to a first embodiment of the present disclosure. The content transmission system of FIG. 1 includes a content recording apparatus 1 and a content playback apparatus 2 which are connected to each other through a wireless transmission path 3. The content recording apparatus 1 records program content which is obtained from another apparatus (not shown), and transmits the program content to the content playback apparatus 2 through the wireless transmission path 3. The content playback apparatus 2 receives the program content from the content recording apparatus 1, and plays back the program content.

The content recording apparatus 1 is provided with a content receiving unit 11, an encoding unit 12, an HDD 13, a wireless transmitting and receiving unit 14, a data rate setting unit 15, and a data rate memory 16. The content recording apparatus 1 is, for example, a hard disk recorder, a BD recorder, or a DVD recorder, having a TV tuner and a hard disk drive, and optionally, further having a drive for removable media such as BDs or DVDs.

The content receiving unit 11 receives program content such as that in a TV broadcast or an IP (Internet Protocol) broadcast. The content receiving unit 11 passes the received program content to the encoding unit 12.

The encoding unit 12 is set with a certain data rate by the data rate setting unit 15. When the content receiving unit 11 inputs the program content to the encoding unit 12, the encoding unit 12 encodes the inputted program content at the set data rate, stores (records) the encoded program content on the HDD 13, and passes the encoded program content to the wireless transmitting and receiving unit 14.

The HDD 13 stores the program content encoded by the encoding unit 12. The HDD 13 may be, for example, any other recording apparatus such as a flash memory.

The wireless transmitting and receiving unit 14 transmits the program content encoded by the encoding unit 12, or the program content encoded by the encoding unit 12 and stored on the HDD 13, to the content playback apparatus 2 through the wireless transmission path 3. The wireless transmitting and receiving unit 14 further receives result information (described later) from the content playback apparatus 2, indicating whether or not the program content transmitted to the content playback apparatus 2 has been correctly played back on the content playback apparatus 2. The wireless transmitting and receiving unit 14 is configured as a device based on wireless techniques such as a wireless LAN or Bluetooth (registered trademark).

The data rate memory 16 stores therein the data rate at which the program content is encoded. The data rate setting unit 15 determines a data rate at which the program content is encoded, based on the result information received from the content playback apparatus 2, and stores the data rate in the data rate memory 16, and further, sets the data rate stored in the data rate memory 16, on the encoding unit 12.

In the present embodiment, the data rate memory 16 stores an initial data rate in advance. The initial data rate may be the original data rate of the program content received by the content receiving unit 11, or a data rate close to the original data rate (or a maximum data rate available to the encoding unit 12), or a minimum data rate available to the encoding unit 12. Further, the data rate memory 16 may store a plurality of data rates, and the data rate setting unit 15 may select one of the plurality of data rates. Further, the data rate may vary according to the relative position between the content recording apparatus 1 and the content playback apparatus 2. For example, when the content playback apparatus 2 is remote from the content recording apparatus 1, the transmission bandwidth is reduced than when they are close to each other. Thus, when the content playback apparatus 2 is remote from the content recording apparatus 1, a lower data rate is used than when they are close to each other.

In the present embodiment, the data rate memory 16 stores therein one data rate associated with result information indicating that the program content transmitted to the content playback apparatus 2 has been correctly played back on the content playback apparatus 2.

The content playback apparatus 2 is provided with a wireless transmitting and receiving unit 21, a decoding unit 22, a received data verifying unit 23, a display 24, and a speaker 25. The content playback apparatus 2 is, for example, a digital TV or a PC. In addition, the content playback apparatus 2 may be provided with a memory or any other storage unit (not shown), for recording therein the program content received from the content recording apparatus 1.

The wireless transmitting and receiving unit 21 receives the program content transmitted from the content recording apparatus 1 through the wireless transmission path 3, and passes the program content to the decoding unit 22. The wireless transmitting and receiving unit 21 is configured as a device based on wireless techniques such as a wireless LAN or Bluetooth.

The decoding unit 22 decodes the program content received by the wireless transmitting and receiving unit 21 for playback, outputs the decoded program content (i.e., the video and audio of the program content) to the display 24 and the speaker 25, and passes decoding information to the received data verifying unit 23. The decoding information indicates whether or not the program content has been correctly decoded without interruption.

The received data verifying unit 23 generates, based on the decoding information inputted from the decoding unit 22, result information indicating whether or not the program content received from the content recording apparatus 1 has been correctly played back on the content playback apparatus 2, and transmits, by the wireless transmitting and receiving unit 21, the result information to the content recording apparatus 1 through the wireless transmission path 3. As the result information, for example, an ACK (Acknowledgement) message may be used when the program content has been correctly played back, and a NACK (Not Acknowledgement) message may be used when the program content has not been correctly played back. Alternatively, when the program content has been correctly played back, a data rate, at which the played-back program content was encoded, may be used as result information. Although the wireless transmission path 3 is used for notifying the result information from the received data verifying unit 23 to the content recording apparatus 1 according to the present embodiment, a different transmission path than the wireless transmission path 3 may be used.

The display 24 and the speaker 25 output the program content played back by the decoding unit 22. Although the display 24 and the speaker 25 of the present embodiment are parts of the content playback apparatus 2, they may be output apparatuses such as an external display and an external speaker connected to the content playback apparatus 2.

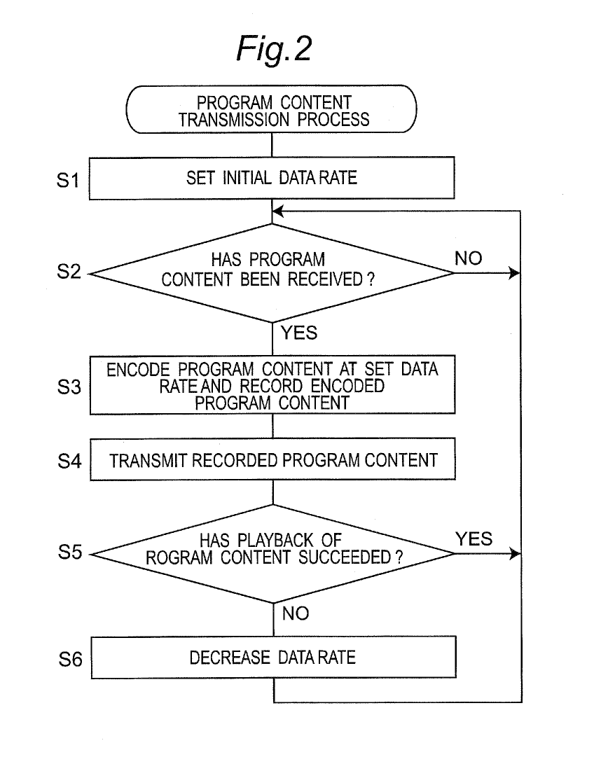

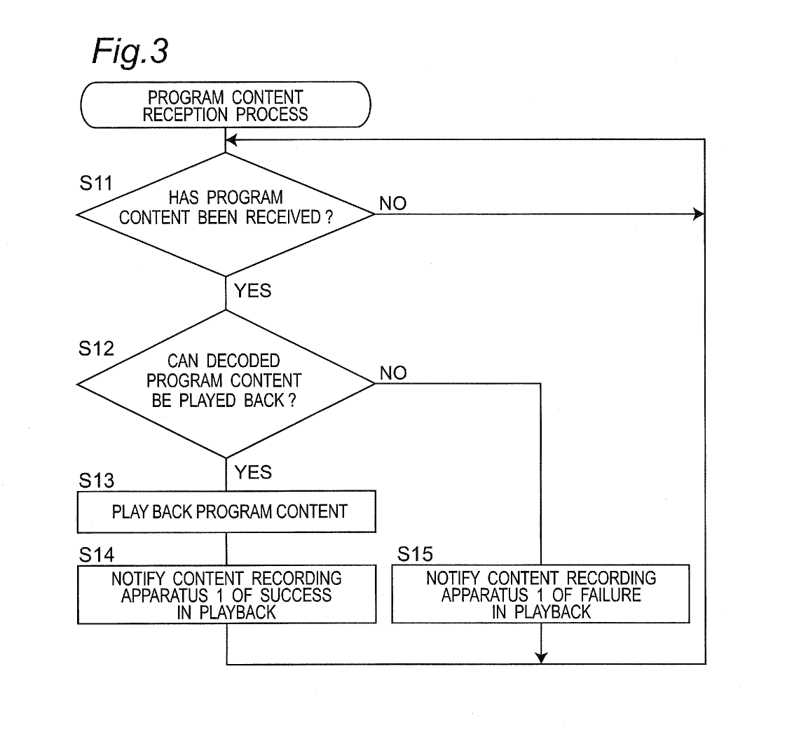

Now, with reference to FIGS. 2 and 3, the operation of the content transmission system of FIG. 1 will be described. FIG. 2 is a flowchart showing a program content transmission process performed by the content recording apparatus 1 of FIG. 1. FIG. 3 is a flowchart showing a program content reception process performed by the content playback apparatus 2 of FIG. 1.

First, at step S1 of FIG. 2, the data rate setting unit 15 of the content recording apparatus 1 sets an initial data rate stored in the data rate memory 16, on the encoding unit 12. In the present embodiment, the initial data rate is a maximum data rate available to the encoding unit 12 (or a relatively high data rate among available data rates). At step S2, if the content receiving unit 11 receives program content such as that in a TV broadcast or an IP broadcast, then the process proceeds to step S3. At step S3, the encoding unit 12 encodes the program content received by the content receiving unit 11, at the data rate set by the data rate setting unit 15, stores the encoded program content on the HDD 13, and passes the encoded program content to the wireless transmitting and receiving unit 14. At step S4, the wireless transmitting and receiving unit 14 transmits the program content encoded by the encoding unit 12, or the program content encoded by the encoding unit 12 and stored on the HDD 13, to the content playback apparatus 2 through the wireless transmission path 3.

Then, at step S11 of FIG. 3, the wireless transmitting and receiving unit 21 of the content playback apparatus 2 receives the program content transmitted from the content recording apparatus 1 through the wireless transmission path 3. At step S12, the decoding unit 22 decodes the program content received by the wireless transmitting and receiving unit 21 for playback, and passes decoding information to the received data verifying unit 23, the decoding information indicating whether or not the program content has been correctly decoded. If the program content has been correctly decoded, then at step S13, the decoding unit 22 outputs the decoded program content to the display 24 and the speaker 25 to play back the program content. Subsequently, at step S14, the received data verifying unit 23 notifies the content recording apparatus 1 of result information through the wireless transmission path 3 using the wireless transmitting and receiving unit 21, the result information indicating that the program content has been correctly played back. On the other hand, if the program content has not been correctly decoded, then at step S15, the received data verifying unit 23 notifies the content recording apparatus 1 of result information through the wireless transmission path 3 using the wireless transmitting and receiving unit 21, the result information indicating that the program content has not been correctly played back.

The wireless transmitting and receiving unit 14 of the content recording apparatus 1 receives the result information from the content playback apparatus 2 through the wireless transmission path 3, and passes the result information to the data rate setting unit 15. At step S5 of FIG. 2, if the data rate setting unit 15 receives the result information indicating that the program content has been correctly played back, then the process returns to step S2. On the other hand, if the data rate setting unit 15 receives the result information indicating that the program content has not been correctly played back, then the process proceeds to step S6, and the data rate setting unit 15 determines to decrease the data rate, and stores the new data rate in the data rate memory 16, and then the process returns to step S2. At step S6, the data rate setting unit 15 may decrease the current data rate by a predetermined amount, or alternatively, if storing a plurality of data rates, may select a lower data rate than the current data rate. The process of steps S2 to S6 is repeated until the content recording apparatus 1 receives result information from the content playback apparatus 2, indicating that the program content has been correctly played back.

The processes shown in FIGS. 2 and 3 are performed, for example, for each program content received by the content receiving unit 11. In this case, the encoding unit 12 encodes each program content at a data rate set by the data rate setting unit 15, and the data rate setting unit 15 determines a data rate at which next program content is encoded, based on result information received from the content playback apparatus 2.

When the data rate setting unit 15 sets a new data rate on the encoding unit 12, the encoding unit 12 re-encodes at the new data rate, program content inputted from the content receiving unit 11, stores the re-encoded program content on the HDD 13, and passes the re-encoded program content to the wireless transmitting and receiving unit 14. In this case, program content stored on the HDD 13, which was encoded at a data rate at which the content playback apparatus 2 could not play back, may be deleted from the HDD 13, or may be overwritten with program content to be newly stored.

As described above, according to the content transmission system of the first embodiment, the data rate at which program content is encoded does not exceed the transmission rate of the wireless transmission path, thus preventing the necessity of re-encoding the program content. Therefore, it is possible to record program content, and simultaneously transmit the recorded program content to the content playback apparatus through the wireless transmission path, so that the content playback apparatus plays back the program content in real time.

### Second Embodiment

The first embodiment describes the case in which when program content transmitted to the content playback apparatus 2 has not been correctly played back on the content playback apparatus 2, the data rate at which the program content is encoded is decreased to a data rate at which the program content can be correctly played back. On the other hand, a second embodiment describes the case in which a low data rate is set as an initial data rate, and as long as program content transmitted to the content playback apparatus 2 can be correctly played back on the content playback apparatus 2, the data rate at which the program content is encoded is increased.

A content transmission system of the second embodiment differs from a content transmission system of the first embodiment only in the operation of the content recording apparatus 1, and accordingly, the operation of the content recording apparatus 1 will be mainly described below.

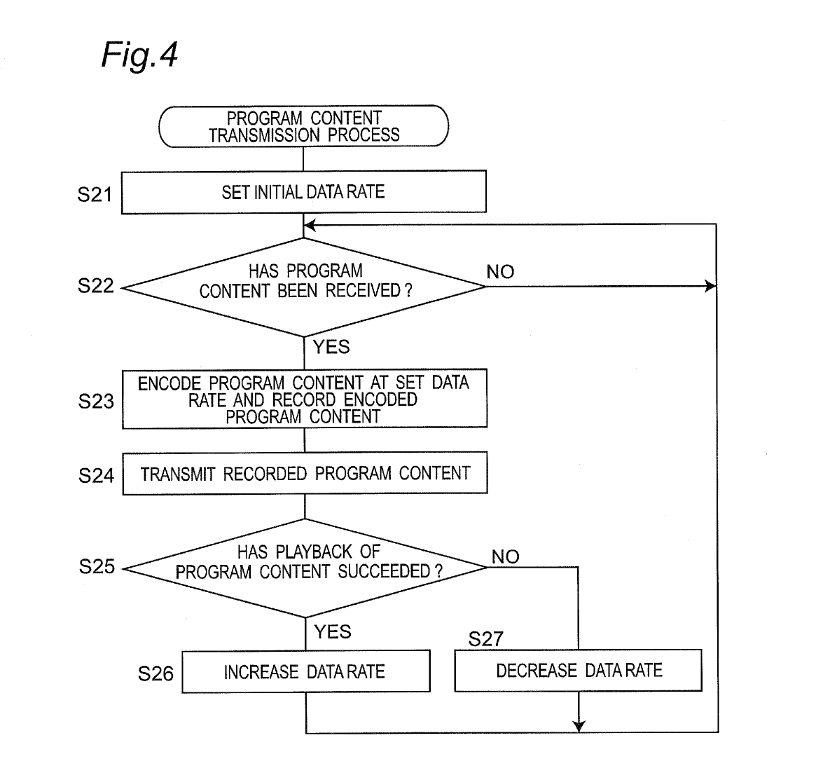

FIG. 4 is a flowchart showing a program content transmission process performed by the content recording apparatus 1 of the content transmission system according to the second embodiment of the present disclosure.

First, at step S21, the content recording apparatus 1 sets, as an initial data rate, a minimum data rate available to an encoding unit 12 (or a relatively low data rate among available data rates) on the encoding unit 12. The process of steps S22 to S24 is the same as that of steps S2 to S4 of FIG. 2. After transmitting program content at step S24, the content playback apparatus 2 performs the program content reception process of FIG. 3.

A wireless transmitting and receiving unit 14 of the content recording apparatus 1 receives result information from the content playback apparatus 2 through a wireless transmission path 3, and passes the result information to a data rate setting unit 15. At step S25, if the data rate setting unit 15 receives result information indicating that the program content has been correctly played back, then the process proceeds to step S26, and if the data rate setting unit 15 receives result information indicating that the program content has not been correctly played back, then the process proceeds to step S27. At step S26, the data rate setting unit 15 determines to increase the data rate, and stores the new data rate in a data rate memory 16, and then, the process returns to step S22. At step S26, the data rate setting unit 15 may increase the current data rate by a predetermined amount, or alternatively, if storing a plurality of data rates, may select a higher data rate than the current data rate. The process of steps S22 to S26 is repeated until the content recording apparatus 1 receives result information from the content playback apparatus 2, indicating that the program content has not been correctly played back. On the other hand, at step S27, the data rate setting unit 15 determines to decrease the data rate, and stores the new data rate in the data rate memory 16, and then, the process returns to step S22. Therefore, the process of steps S22 to S26 is repeated until the content recording apparatus 1 receives result information from the content playback apparatus 2, indicating that the program content has not been correctly played back, and when the content recording apparatus 1 receives result information from the content playback apparatus 2, indicating that the program content has not been correctly played back, the data rate is decreased by one level at step S27.

According to the second embodiment, a minimum data rate available to the encoding unit 12 is set as an initial data rate. Alternatively, a maximum data rate available to the encoding unit 12 (e.g., a data rate close to the original data rate of program content received by a content receiving unit 11) may be set as an initial data rate, and the data rate may be decreased until receiving result information indicating that the program content has been correctly played back.

According to the first and second embodiments, the encoding unit 12 stores encoded program content on an HDD 13 at all times. Alternatively, when the data rate setting unit 15 receives result information indicating that program content has been correctly played back (for example, the last one of a plurality of pieces of result information indicating that the program content has been correctly played back), the data rate setting unit 15 may notify the encoding unit 12 of the result information, and the encoding unit 12 may store encoded program content on the HDD 13 after receiving the notification.

As described above, according to the content transmission system of the second embodiment, the content recording apparatus 1 can encode program content at the highest one of the data rates at which the program content transmitted to the content playback apparatus 2 is correctly played back on the content playback apparatus 2. Therefore, it is possible to record program content at a high data rate, and simultaneously transmit the recorded program content to the content playback apparatus through the wireless transmission path, so that the content playback apparatus plays back the program content in real time.

### Third Embodiment

According to the first and second embodiments, the content recording apparatus 1 transmits a piece of program content encoded at one data rate, to the content playback apparatus 2, receives result information from the content playback apparatus, indicating whether or not the program content has been correctly played back, and determines a data rate based on the result information. According to a third embodiment, a content recording apparatus 1 transmits a plurality of pieces of program content encoded at a plurality of data rates, respectively, to a content playback apparatus 2, receives pieces of result information from the content playback apparatus 2, indicating whether or not each of the plurality of pieces of program content transmitted to the content playback apparatus 2 has been correctly played back on the content playback apparatus 2, and determines a data rate based on the pieces of result information.

A content transmission system of the third embodiment differs from a content transmission system of the first embodiment only in the operation of the content recording apparatus 1, and accordingly, the operation of the content recording apparatus 1 will be mainly described below.

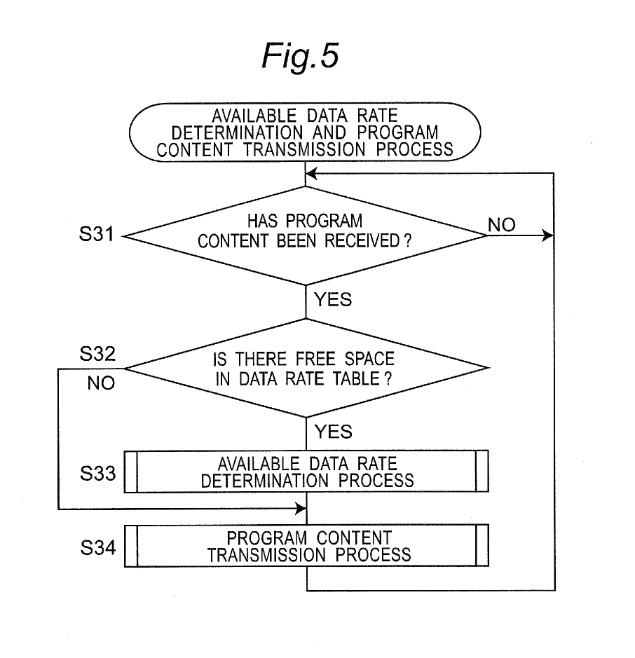

FIG. 5 is a flowchart showing an available data rate determination and program content transmission process performed by the content recording apparatus 1 of the content transmission system according to the third embodiment of the present disclosure. At step S31, if a content receiving unit 11 receives program content such as that in a TV broadcast or an IP broadcast, then an encoding unit 12 notifies a data rate setting unit 15 of the presence of the program content to be encoded, and the process proceeds to step S32. At step S32, the data rate setting unit 15 determines whether or not there is free space in a data rate table of a data rate memory 16. At step S32, if YES, then the process proceeds to step S33, and if NO, then the process proceeds to step S34.

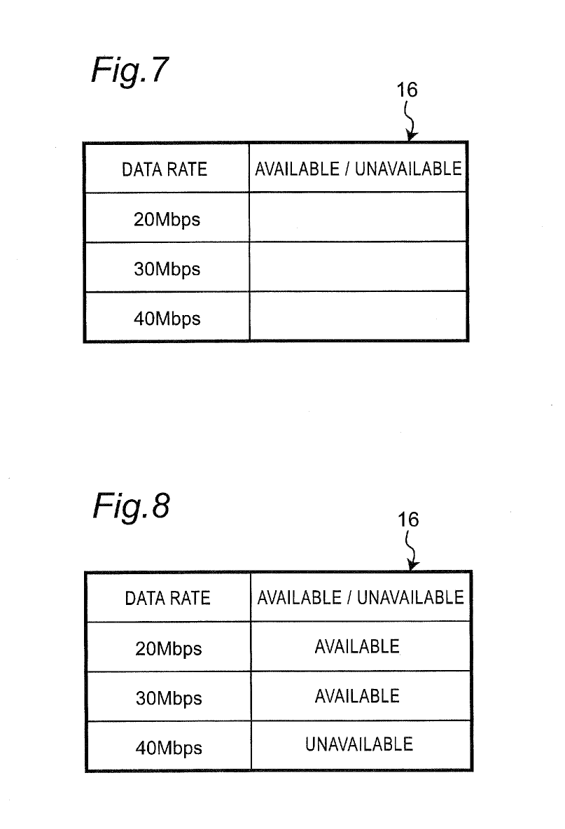

According to the present embodiment, the data rate memory 16 is storing a data rate table including a plurality of data rates. FIG. 7 is a diagram showing a state in which there is free space in the data rate table stored in the data rate memory 16 of the content recording apparatus 1 in the content transmission system according to the third embodiment of the present disclosure. The data rate table stores a plurality of data rates in advance, and stores pieces of result information in association with the plurality of data rates, respectively, the pieces of result information indicating whether or not pieces of program content transmitted to the content playback apparatus 2 have been correctly played back on the content playback apparatus 2 (i.e., available/unavailable information flags each indicating whether or not a data rate is available for encoding program content). In the example of FIG. 7, available/unavailable information is not stored.

In the present embodiment, different steps S33 and S34 are performed according to whether or not there is free space in the data rate table. An available data rate determination process at step S33 is performed to determine the availabilities of all data rates in the data rate table, whose availabilities are not determined. At this time, the content recording apparatus 1 encodes program content at a plurality of data rates, and sequentially transmits the pieces of encoded program content on trial (e.g., one minute of each piece of encoded program content). A program content transmission process at step S34 is performed to transmit program content based on the contents of the data rate table. At this time, the content recording apparatus 1 encodes the program content at the highest one of all available data rates in the data rate table, and transmits the encoded program content to the content playback apparatus 2. Then, when the content recording apparatus 1 receives result information from the content playback apparatus 2, indicating that the program content has not been correctly played back, the content recording apparatus 1 updates the data rate table.

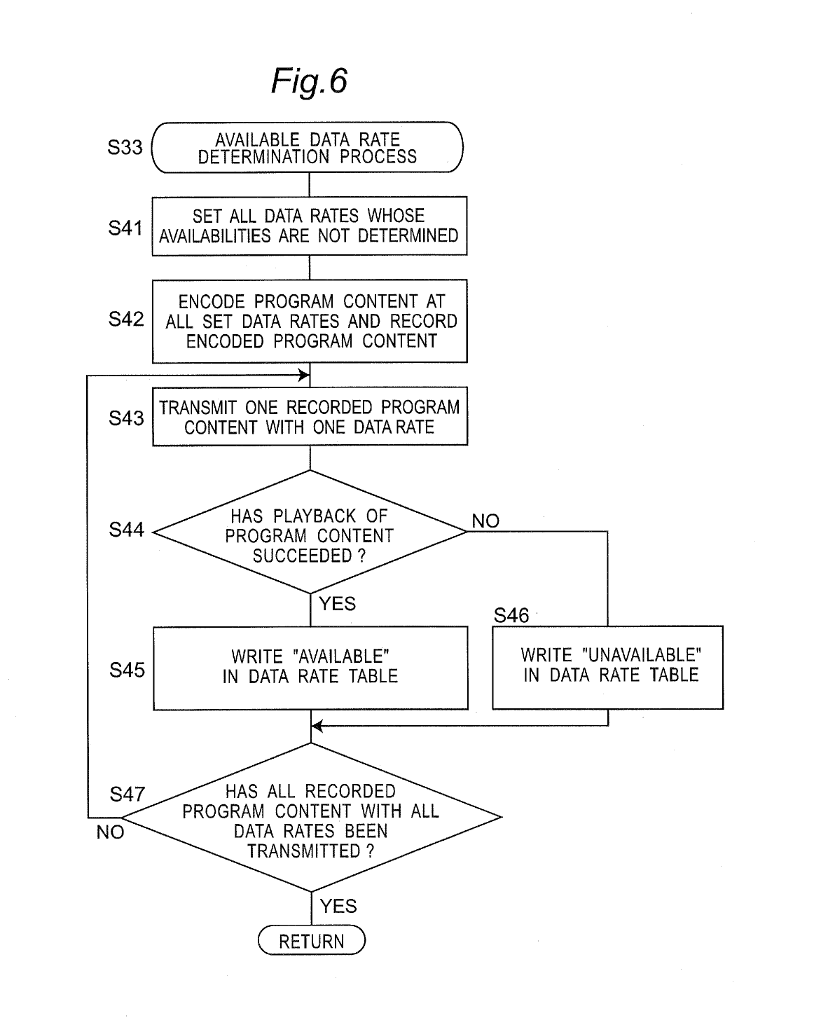

FIG. 6 is a flowchart showing a subroutine of the available data rate determination process S33 of FIG. 5. At step S41, the data rate setting unit 15 sets all data rates in the data rate table, whose availabilities are not determined, on the encoding unit 12. Then, at step S42, the encoding unit 12 encodes the program content at all the data rates set by the data rate setting unit 15, and stores (records) the pieces of encoded program content on an HDD 13.

The encoding unit 12 may include a plurality of encoders, and simultaneously encode the program content at a plurality of data rates set by the data rate setting unit 15.

Alternatively, the encoding unit 12 may include only one encoder rather than a plurality of encoders. In this case, at first, the data rate setting unit 15 sets one of the data rates in the data rate table, whose availabilities are not determined, on the encoding unit 12. The encoding unit 12 encodes the program content at the set data rate and records the encoded program content. When the encoding is done, the encoding unit 12 notifies the data rate setting unit 15 that the encoding is done. When the data rate setting unit 15 receives notification from the encoding unit 12, indicating that the recording is done, the data rate setting unit 15 selects one of the other data rates in the data rate table, whose availabilities are not determined, and sets the selected data rate as a new data rate on the encoding unit 12. The data rate setting unit 15 and the encoding unit 12 repeat steps S41 and S42 until encoding is done at all the data rates.

At step S43, the wireless transmitting and receiving unit 14 transmits one of the plurality of pieces of program content encoded by the encoding unit 12 and stored on the HDD 13, to the content playback apparatus 2 through a wireless transmission path 3. The program content transmitted at step S43 may be, for example, only a portion of the encoded program content corresponding to a part of an entire duration of the encoded program content (e.g., one minute). After transmitting the program content at step S43, the content playback apparatus 2 performs the program content reception process of FIG. 3. A wireless transmitting and receiving unit 14 receives result information from the content playback apparatus 2 through the wireless transmission path 3, and passes the result information to the data rate setting unit 15. At step S44, if the data rate setting unit 15 receives result information indicating that the program content has been correctly played back, then the process proceeds to step S45, and if the data rate setting unit 15 receives result information indicating that the program content has not been correctly played back, then the process proceeds to step S46. At step S45, the data rate setting unit 15 writes “available” in the data rate table, in association with the data rate used to encode the program content transmitted at step S43. At step S46, the data rate setting unit 15 writes “unavailable” in the data rate table, in association with the data rate used to encode the program content transmitted at step S43. At step S47, it is determined whether or not all the pieces of recorded program content with all the data rates have been transmitted. At step S47, if YES, then the process proceeds to step S34 of FIG. 5, and if NO, then the process returns to step S43.

FIG. 8 is a diagram showing a state in which available/unavailable information is written in the data rate table stored in the data rate memory 16 of the content recording apparatus 1 in the content transmission system according to the third embodiment of the present disclosure. “Available” is stored in association with data rates of 20 Mbps and 30 Mbps, and “unavailable” is stored in association with a data rate of 40 Mbps.

In FIG. 6, every time one piece of program content with one data rate is transmitted at step S43, the content recording apparatus 1 receives result information from the content playback apparatus 2. However, after transmitting all pieces of program content encoded at step S42, the content recording apparatus 1 may receive all pieces of result information for all the pieces of program content at once from the content playback apparatus 2.

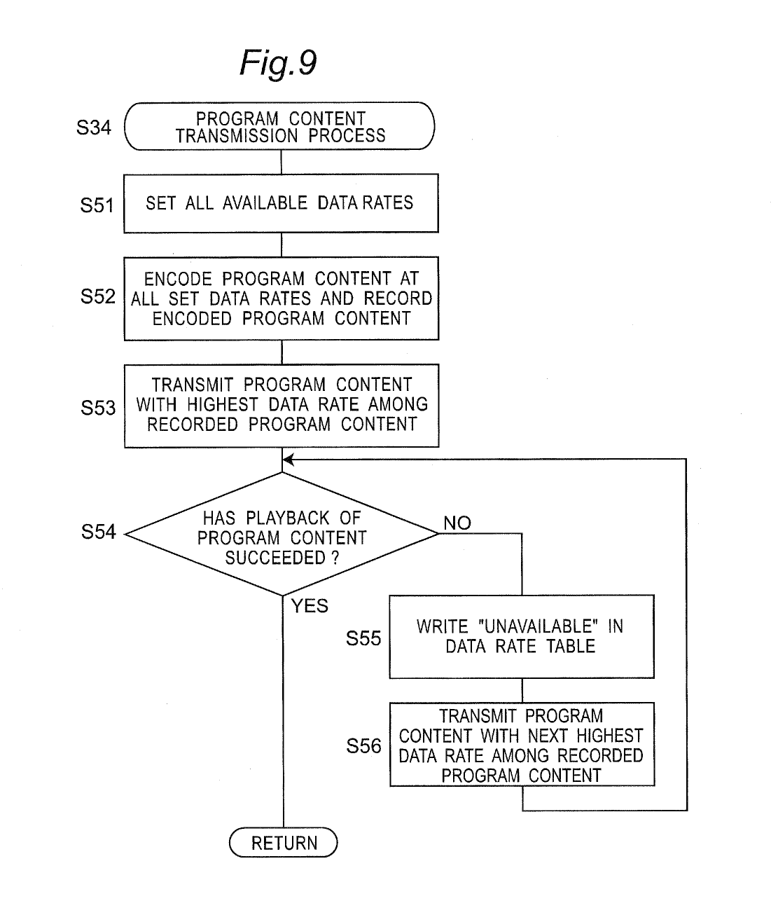

FIG. 9 is a flowchart showing a subroutine of the program content transmission process S34 of FIG. 5. At step S51, the data rate setting unit 15 sets all available data rates in the data rate table, on the encoding unit 12. Then, at step S52, the encoding unit 12 encodes program content at all the data rates set by the data rate setting unit 15, and stores (records) the pieces of encoded program content on the HDD 13. At step S53, the wireless transmitting and receiving unit 14 transmits one piece of program content with the highest data rate, among the plurality of pieces of program content encoded by the encoding unit 12 and stored on the HDD 13, to the content playback apparatus 2 through the wireless transmission path 3. For example, when the data rate table stored in the data rate memory 16 includes available/unavailable information shown in FIG. 8, the data rate setting unit 15 sets a higher one of “available” data rates of 20 Mbps and 30 Mbps, i.e., 30 Mbps, on the encoding unit 12. After transmitting the program content at step S53, the content playback apparatus 2 performs the program content reception process of FIG. 3. The wireless transmitting and receiving unit 14 receives result information from the content playback apparatus 2 through the wireless transmission path 3, and passes the result information to the data rate setting unit 15. At step S54, the data rate setting unit 15 determines whether or not playback of the program content has succeeded. At step S54, if YES, then the process returns to step S31 of FIG. 5, and if NO, then the process proceeds to step S55. At step S55, the data rate setting unit 15 writes “unavailable” in the data rate table, in association with the data rate used to encode the program content transmitted at step S53. Then, at step S56, the wireless transmitting and receiving unit 14 transmits a piece of program content with the next highest data rate, among the plurality of pieces of program content encoded by the encoding unit 12 and stored on the HDD 13.

According to the program content transmission process of FIG. 9, since program content is encoded at each of all available data rates (step S52), when it becomes unable to correctly play back the program content during transmission of the program content, it is possible to continue the transmission by immediately changing the program content for program content with the next highest data rate (step S56).

When it is determined at step S54 that playback of a piece of program content encoded at any of the data rates has succeeded, those pieces of program content stored on the HDD 13, other than the piece of program content being transmitted to the content playback apparatus 2, may be deleted from the HDD 13, or may be overwritten with program content to be newly stored.

When there is free space in the data rate table of the data rate memory 16, the encoding unit 12 may encode only a portion of program content corresponding to a part of an entire duration of the program content (e.g., one minute) (step S42 of FIG. 6). When it is determined that playback of a piece of program content encoded at any of the data rates has succeeded (step S54 of FIG. 9), the encoding unit 12 encodes the entire program content. By encoding only a part of the program content, it is possible to reduce the time to finally determine a data rate at which the program content is encoded.

Further, every time program content is received, the data rate table may be reset to newly determine whether data rates are available or unavailable. Alternatively, after determining whether data rates are available or unavailable, based on firstly received program content, the constant data rate table may be used. Further, the data rate table may be periodically reset to newly determine whether data rates are available or unavailable.

As described above, according to the content transmission system of the third embodiment, the content recording apparatus 1 transmits a plurality of pieces of program content encoded at a plurality of data rates, respectively, to the content playback apparatus 2, receives pieces of result information from the content playback apparatus 2, indicating whether or not each of the plurality of pieces of program content transmitted to the content playback apparatus 2 has been correctly played back on the content playback apparatus 2, and determines a data rate based on the pieces of result information. Therefore, without a data rate at which program content is encoded not exceeding the transmission rate of the wireless transmission path, it is possible to record program content at the highest data rate, and simultaneously transmit the recorded program content to the content playback apparatus through the wireless transmission path, so that the content playback apparatus plays back the program content in real time.

Further, when a plurality of data rates are stored in the first and second embodiments, a data rate table as shown in FIG. 7 may be stored in the data rate memory 16.

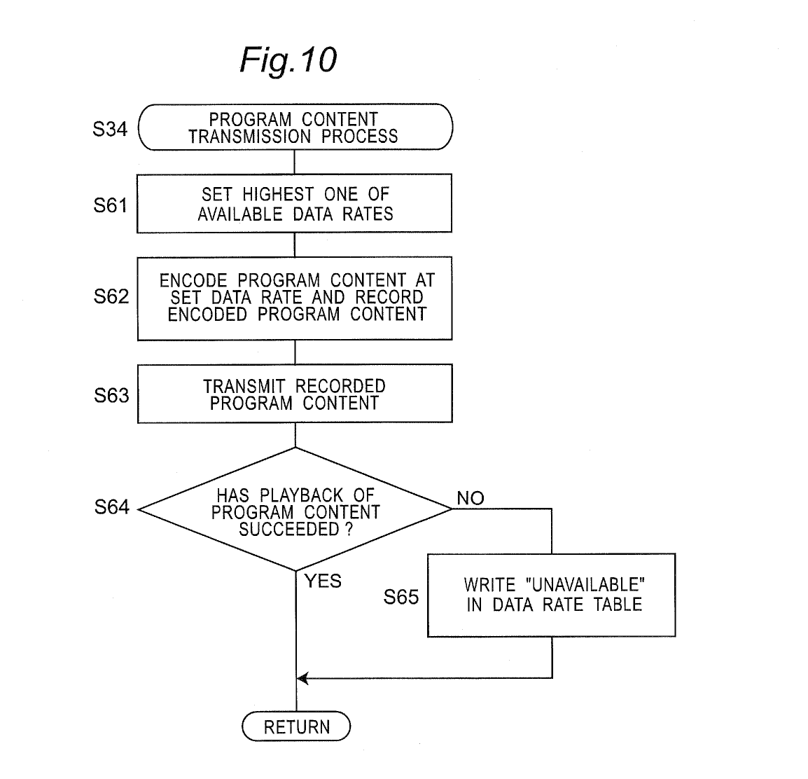

FIG. 10 is a flowchart showing a subroutine of a program content transmission process S34 which is performed by a content recording apparatus 1 of a content transmission system according to a modified embodiment of the third embodiment of the present disclosure. At step S61, a data rate setting unit 15 sets the highest one of available data rates on an encoding unit 12. At step S62, the encoding unit 12 encodes program content at the data rate set by the data rate setting unit 15, and stores (records) the encoded program content on an HDD 13. At step S63, a wireless transmitting and receiving unit 14 transmits the program content encoded by the encoding unit 12 and stored on the HDD 13, to a content playback apparatus 2 through a wireless transmission path 3. After transmitting the program content at step S63, the content playback apparatus 2 performs the program content reception process of FIG. 3. The wireless transmitting and receiving unit 14 receives result information from the content playback apparatus 2 through the wireless transmission path 3, and passes the result information to the data rate setting unit 15. At step S64, the data rate setting unit 15 determines whether or not playback of the program content has succeeded. At step S64, if YES, then the process returns to step S31 of FIG. 5, and if NO, then the process proceeds to step S65. At step S65, the data rate setting unit 15 writes “unavailable” in the data rate table, in association with the data rate used to encode the program content transmitted at step S63.

According to the program content transmission process of FIG. 10, since program content is recorded only at the highest one of available data rates, unnecessary encoding processes are eliminated, as compared to the program content transmission process of FIG. 9.

### Fourth Embodiment

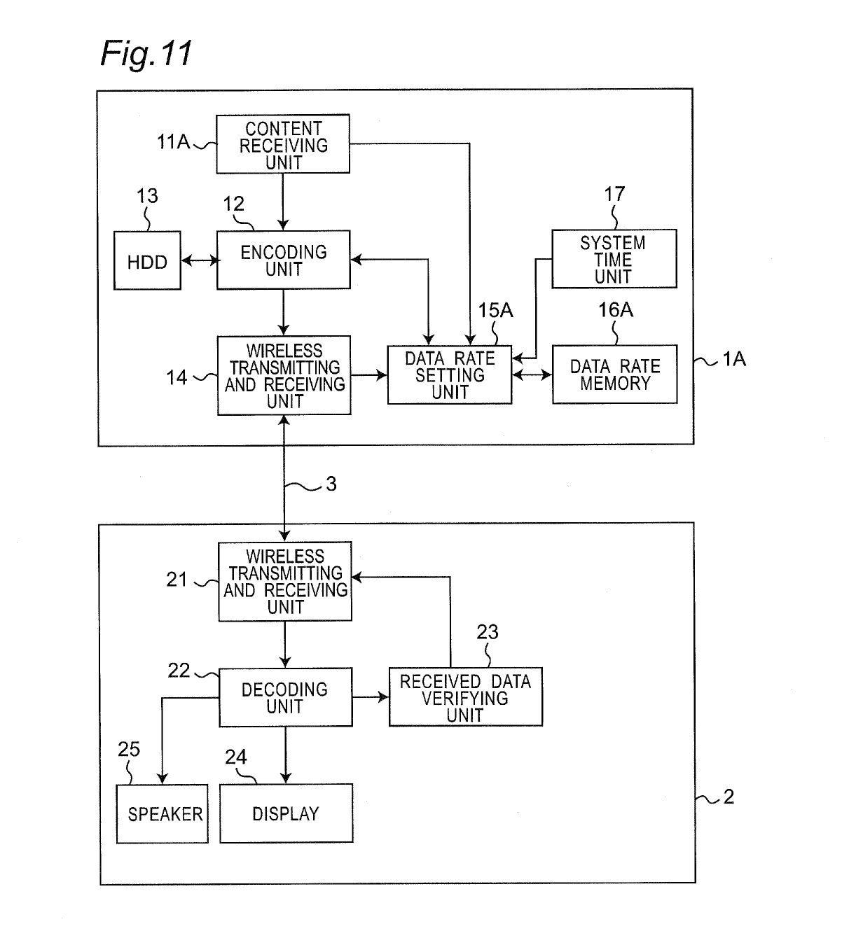

FIG. 11 is a block diagram showing a configuration of a content transmission system according to a fourth embodiment of the present disclosure. The content transmission system of FIG. 11 includes a content recording apparatus 1A and a content playback apparatus 2 which are connected to each other through a wireless transmission path 3. The content recording apparatus 1A records program content which is obtained from another apparatus (not shown), and transmits the program content to the content playback apparatus 2 through the wireless transmission path 3. The content playback apparatus 2 receives the program content from the content recording apparatus 1A, and plays back the program content. The content transmission system of the fourth embodiment differs from that of the first embodiment only in the configuration of the content recording apparatus 1A, and thus, the operation of the content recording apparatus 1A will be mainly described below.

As shown in FIG. 11, the content recording apparatus 1A is provided with a content receiving unit 11A, an encoding unit 12, an HDD 13, a wireless transmitting and receiving unit 14, a data rate setting unit 15A, a data rate memory 16A, and a system time unit 17. Those components that perform the same operation as those of the first embodiment are denoted by the same reference signs, and their descriptions are omitted.

The system time unit 17 maintains a date, a day of week, and a time, and passes the date and time information to the data rate setting unit 15A.

The content receiving unit 11A extracts attribute information of program content included in the received program content, and passes the attribute information to the data rate setting unit 15A. The attribute information of the program content includes the program name, broadcast date and time (start time and end time), broadcast day of week, etc., of the program content.

The data rate setting unit 15A determines a data rate at which the program content is encoded, based on result information received from the content playback apparatus 2, stores the data rate in the data rate memory 16A, and sets the data rate stored in the data rate memory 16A, on the encoding unit 12. The data rate setting unit 15A stores in the data rate memory 16A, the attribute information of the program content inputted from the content receiving unit 11A, in association with the data rate.

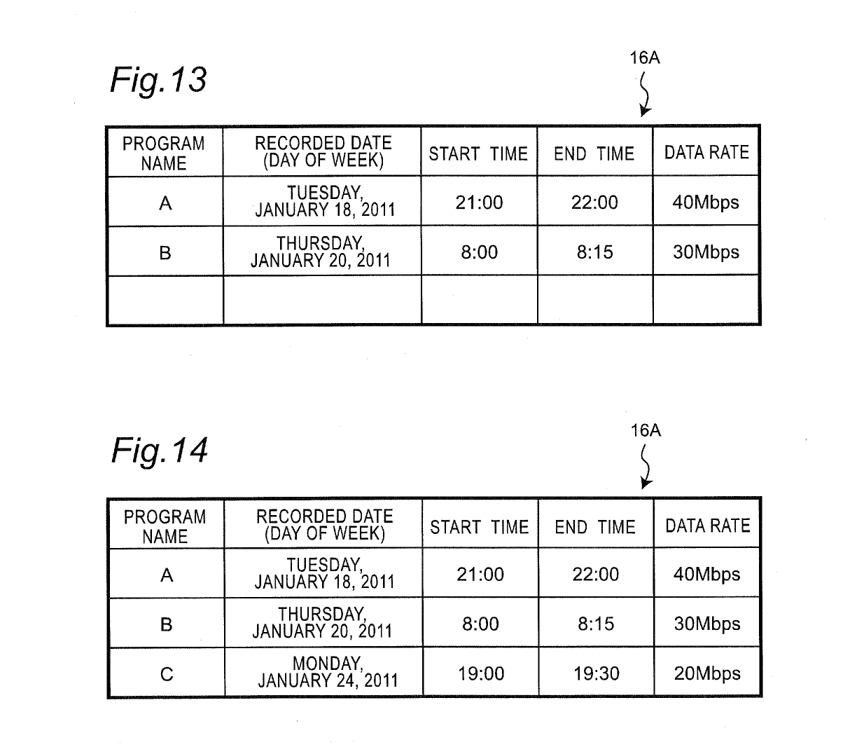

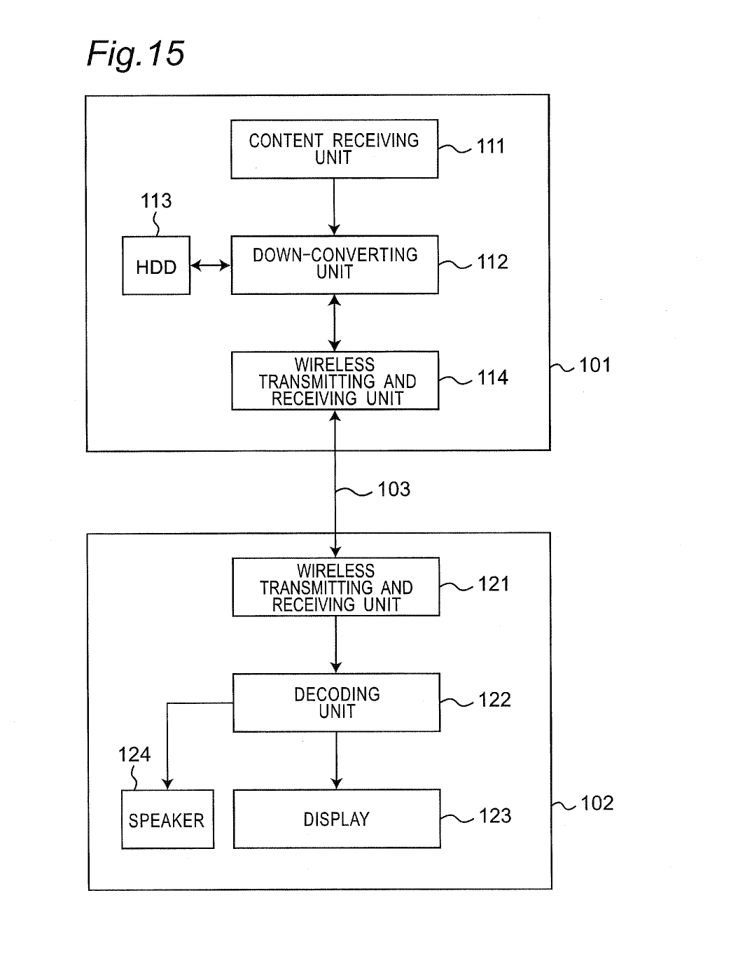

For each of at least one piece of program content having been correctly played back on the content playback apparatus 2, the data rate memory 16A stores therein a data rate used to encode the program content, and attribute information uniquely identifying the program content. FIG. 13 is a diagram showing a first state of a data rate table stored in the data rate memory 16A of FIG. 11. In the state shown in FIG. 13, the attribute information and data rates are stored for two programs A and B. As shown in FIG. 13, the data rate table includes, for example, a program name of program content, a recorded date (including a day of week) at which the program content is recorded, the start and end times of recording the program content, and a data rate. The data rate table shown in FIG. 13 is an example, and thus, does not need to include all the entries shown in the drawing, and may include other entries.

If the data rate memory 16A is storing substantially the same attribute information as the attribute information of program content that is received by the content receiving unit 11A and is to be newly encoded, the data rate setting unit 15A sets a data rate associated with the attribute information stored in the data rate memory 16A (i.e., a data rate used to encode program content which was correctly played back on the content playback apparatus 2), on the encoding unit 12.

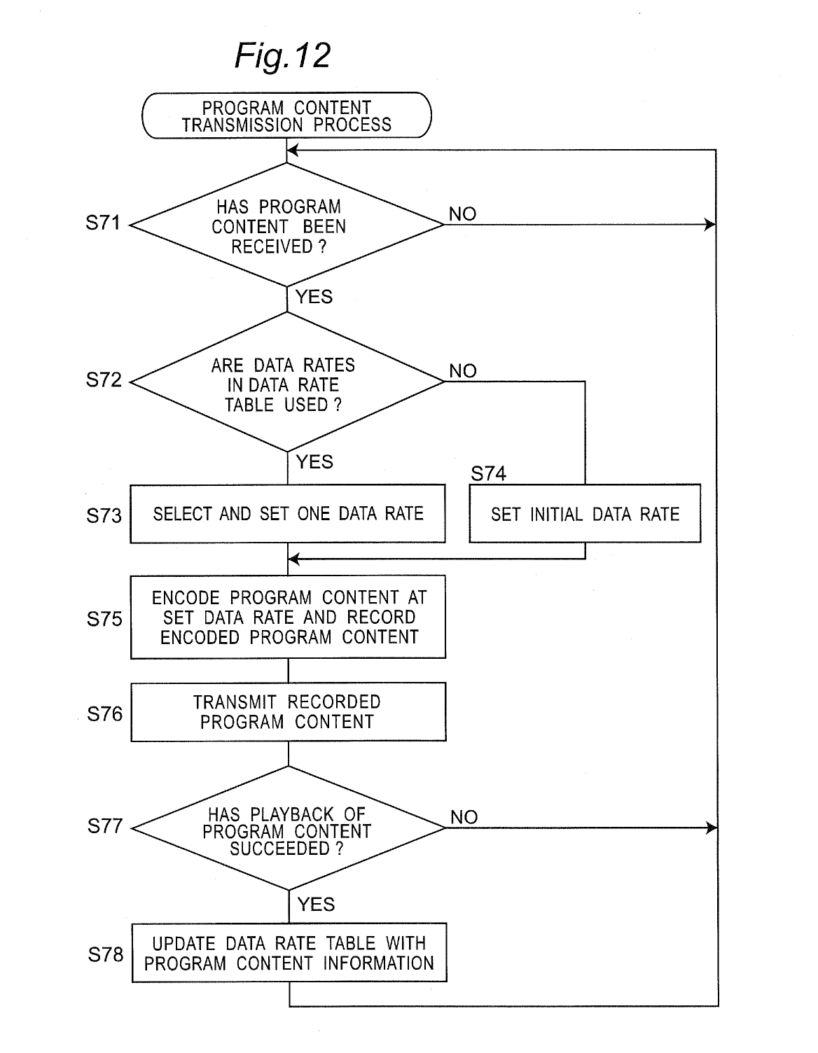

FIG. 12 is a flowchart showing a program content transmission process performed by the content recording apparatus 1A of FIG. 11. At step S71, when the content receiving unit 11A receives program content, the encoding unit 12 instructs the data rate setting unit 15A to set a data rate at which the program content is encoded, and the process proceeds to step S72. At step S72, the data rate setting unit 15A determines whether or not the data rate table is storing an attribute information and a data rate associated with the attribute information, the attribute information being substantially the same as the attribution information of the program content received by the content receiving unit 11A, and determines whether or not to use the stored data rate. At step S72, if YES, then the process proceeds to step S73, and if NO, then the process proceeds to step S74. At step S73, for example, if the data rate table is storing a set of attribute information, in which at least one of the program name, recorded date, start time, and end time is the same as that of the program content received by the content receiving unit 11A, then the data rate setting unit 15A considers that the received program content has the same attribute information as the one set of attribute information, and thus, selects and set the same data rate as the data rate associated with the one set of attribute information.

For example, referring to the data rate table of FIG. 13, suppose that program content received by the content receiving unit 11A has the program name of “program B”, and the current date is Thursday, January 27, which is one week from Thursday, Jan. 20, 2011. If the start and end times of recording the received program content are the same as those of the program B, then a data rate of 30 Mbps is selected and set. A criterion for selecting a data rate is not limited thereto. For example, even if the start and end times of recording received program content are not the same as those stored in the data rate table, when the program name of the received program content is the same as that stored in the data rate table (indicating the same program content), the same data rate may be selected and set as that stored in the data rate table associated with a set of attribute information including the program name.

On the other hand, at step S74, the data rate setting unit 15A sets an initial data rate, rather than using any of the data rates stored in the data rate table. The initial data rate is set, for example, in the same manner as that of the first or second embodiment.

At step S75, the encoding unit 12 encodes the program content received by the content receiving unit 11A, at the data rate set by the data rate setting unit 15A, stores the encoded program content on the HDD 13, and passes the encoded program content to the wireless transmitting and receiving unit 14. At step S76, the wireless transmitting and receiving unit 14 transmits the program content encoded by the encoding unit 12, or the program content encoded by the encoding unit 12 and stored on the HDD 13, to the content playback apparatus 2 through the wireless transmission path 3. After transmitting the program content at step S76, the content playback apparatus 2 performs the program content reception process of FIG. 3. The wireless transmitting and receiving unit 14 receives result information from the content playback apparatus 2 through the wireless transmission path 3, and passes the result information to the data rate setting unit 15A.

At step S77, it is determined whether or not playback of the program content has succeeded. At step S77, if YES, then the process proceeds to step S78, and if NO, then the process returns to step S71. At step S78, the data rate setting unit 15A updates the data rate table by storing, in the data rate table, the data rate used to encode the program content transmitted at step S63, the program name, recorded date (day of week), start time, and end time, etc. of the program content.

FIG. 14 is a diagram showing a second state of the data rate table stored in the data rate memory 16A of FIG. 11. In the state shown in FIG. 14, the attribute information and data rate are further stored for a program C, in addition to the state shown in FIG. 13. For example, assume that when the data rate table is in the state shown in FIG. 13, a program C is recorded from 19:00 to 19:30, Monday, Jan. 24, 2011, at a data rate of 20 Mbps. In this case, since the program C is not registered in the data rate table of FIG. 13, the program C is registered, thus resulting in the state shown in FIG. 14. In addition, for already registered programs, the data rate table is updated by overwriting only changed entries, or the data rate table is entirely updated.

The attribute information of program content is not limited to that shown in FIGS. 13 and 14, and may include, for example, at least one of the name and the broadcast date and time of program content, or may include other information.

The content transmission system of the present embodiment is suitable for the case where a plurality of content playback apparatuses 2 installed in different locations play back recorded program content, or for the case where a mobile content playback apparatus 2 plays back recorded program content (a mobile apparatus capable of usually playing back in a living room, and plays back in a bedroom at late night, etc.). For example, the content transmission system of the present embodiment is useful for the case where the content transmission system includes one content recording apparatus 1A and a plurality of content playback apparatuses 2, and is shared by a plurality of users at home, and the users record different pieces of program content every week during their respective schedules, and play back the pieces of recorded program content using the different content playback apparatuses 2 (e.g., content payback apparatuses 2 installed in different rooms).

As described above, according to the content transmission system of the fourth embodiment, the content recording apparatus 1A can store, in the data rate table, a data rate at which program content transmitted to the content playback apparatus 2 is correctly played back on the content playback apparatus 2, together with the attribute information such as date and time, and can use the data rate stored in the data rate table when encoding program content. Therefore, it is possible to record program content at a data rate suitable for the attribute information (e.g., a date, a day of week, and a time of day) of the program content, and simultaneously transmit the recorded program content to the content playback apparatus through the wireless transmission path, so that the content playback apparatus plays back the program content in real time.

Further, the content recording apparatus and content playback apparatus of each embodiment can be configured using a program and a computer including means embodying their functions and operations. Further, a part or all the content recording apparatus and content playback apparatus of each embodiment may be configured by hardware.

Each of the embodiments describes the present disclosure not restrictively, but illustratively. Therefore, the present disclosure can be implemented as various other modified embodiments and changed embodiments, and the scope of the present disclosure is defined only by the claims.

According to aspects of the present disclosure, a content recording apparatus, a content recording method, and a content transmission system are provided as follows.

According to a first aspect of the present disclosure, there is provided a content recording apparatus connected to a content playback apparatus through a wireless transmission path. The content recording apparatus is provided with: an encoding unit for encoding program content at a data rate; a program content storage for storing the encoded program content; a wireless transmitting and receiving unit for transmitting the encoded program content to the content playback apparatus; a data rate memory for storing the data rate at which the program content is encoded; and a data rate setting unit for setting the data rate stored in the data rate memory, on the encoding unit. The wireless transmitting and receiving unit receives result information from the content playback apparatus, the result information indicating whether or not the program content transmitted to the content playback apparatus has been correctly played back on the content playback apparatus. The data rate setting unit determines, based on the result information, a data rate at which the program content is encoded, and stores the data rate in the data rate memory.

According to a second aspect of the present disclosure, in the first aspect of the present disclosure, when the data rate setting unit receives result information indicating that the program content has not been correctly played back, the data rate setting unit determines to decrease the data rate, and stores the decreased data rate in the data rate memory.

According to a third aspect of the present disclosure, in the first or second aspect of the present disclosure, when the data rate setting unit receives result information indicating that the program content has been correctly played back, the data rate setting unit determines to increase the data rate, and stores the increased data rate in the data rate memory.

According to a fourth aspect of the present disclosure, in the first aspect of the present disclosure, the data rate memory stores a plurality of data rates. The encoding unit encodes the program content at each of the plurality of data rates. The wireless transmitting and receiving unit transmits the plurality of pieces of program content encoded at the plurality of data rates, respectively, to the content playback apparatus, and receives pieces of result information from the content playback apparatus, each of the pieces of result information indicating whether or not each of the plurality of pieces of program content transmitted to the content playback apparatus has been correctly played back on the content playback apparatus. The data rate setting unit stores the pieces of result information in the data rate memory, in association with the plurality of data rates, respectively.

According to a fifth aspect of the present disclosure, in the fourth aspect of the present disclosure, the encoding unit encodes the program content at all those of the plurality of data rates that are associated with pieces of result information indicating that the program content has been correctly played back.

According to a sixth aspect of the present disclosure, in the fourth aspect of the present disclosure, the encoding unit encodes the program content at the highest one of the plurality of data rates that is associated with a piece of result information indicating that the program content has been correctly played back.

According to a seventh aspect of the present disclosure, in one of the fourth to sixth aspects of the present disclosure, when result information associated with any of the plurality of data rates is not stored in the data rate memory, the encoding unit encodes only a portion of the program content corresponding to a part of an entire duration of the program content.

According to an eighth aspect of the present disclosure, in one of the first to seventh aspects of the present disclosure, For each of at least one piece of program content having been correctly played back on the content playback apparatus, the data rate memory stores therein a data rate used to encode the program content, and attribute information uniquely identifying the program content. When the data rate memory stores therein substantially same attribute information as attribute information of program content to be encoded, the data rate setting unit sets a data rate associated with the attribute information stored in the data rate memory, on the encoding unit.

According to a ninth aspect of the present disclosure, in the eighth aspect of the present disclosure, the attribute information includes at least one of a name of the program content, and broadcast date and time of the program content.

According to a tenth aspect of the present disclosure, there is provided a content recording method for a content recording apparatus connected to a content playback apparatus through a wireless transmission path, the content recording apparatus provided with an encoding unit, a program content storage, and a data rate memory. The content recording method includes: setting a data rate stored in the data rate memory, on the encoding unit; encoding, by the encoding unit, program content at the set data rate; storing the encoded program content in the program content storage; wirelessly transmitting the encoded program content to the content playback apparatus; wirelessly receiving result information from the content playback apparatus, the result information indicating whether or not the program content transmitted to the content playback apparatus has been correctly played back on the content playback apparatus; and determining, based on the result information, a data rate at which the program content is encoded, and storing the data rate in the data rate memory.

According to an eleventh aspect of the present disclosure, in the tenth aspect of the present disclosure, the storing includes determining to decrease the data rate, and storing the decreased data rate in the data rate memory, when receiving result information indicating that the program content has not been correctly played back.

According to a twelfth aspect of the present disclosure, in the tenth or eleventh aspect of the present disclosure, the storing includes determining to increase the data rate, and storing the increased data rate in the data rate memory, when receiving result information indicating that the program content has been correctly played back.

According to a thirteenth aspect of the present disclosure, in the tenth aspect of the present disclosure, the data rate memory stores therein a plurality of data rates. The content recording method includes: encoding, by the encoding unit, the program content at each of the plurality of data rates; wirelessly transmitting the plurality of pieces of program content encoded at the plurality of data rates, respectively, to the content playback apparatus; wirelessly receiving pieces of result information from the content playback apparatus, each of the pieces of result information indicating whether or not each of the plurality of pieces of program content transmitted to the content playback apparatus has been correctly played back on the content playback apparatus; and storing the pieces of result information in the data rate memory, in association with the plurality of data rates, respectively.

According to a fourteenth aspect of the present disclosure, in the thirteenth aspect of the present disclosure, the content recording method includes encoding, by the encoding unit, the program content at all those of the plurality of data rates that are associated with pieces of result information indicating that the program content has been correctly played back.

According to a fifteenth aspect of the present disclosure, in the thirteenth aspect of the present disclosure, the content recording method includes encoding, by the encoding unit, the program content at the highest one of the plurality of data rates that is associated with a piece of result information indicating that the program content has been correctly played back.

According to a sixteenth aspect of the present disclosure, in one of the thirteenth to fifteenth aspects of the present disclosure, the encoding includes encoding, by the encoding unit, only a portion of the program content corresponding to a part of an entire duration of the program content, when result information associated with any of the plurality of data rates is not stored in the data rate memory.

According to a seventeenth aspect of the present disclosure, in one of the tenth to sixteenth aspects of the present disclosure, for each of at least one piece of program content having been correctly played back on the content playback apparatus, the data rate memory stores therein a data rate used to encode the program content, and attribute information uniquely identifying the program content. The content recording method includes, when the data rate memory stores therein substantially same attribute information as attribute information of program content to be encoded, setting a data rate associated with the attribute information stored in the data rate memory, on the encoding unit.

According to an eighteenth aspect of the present disclosure, in the seventeenth aspect of the present disclosure, the attribute information includes at least one of a name the program content, and broadcast date and time of the program content.

According to a nineteenth aspect of the present disclosure, there is provided a content transmission system provided with: a content recording apparatus according to one of the first to the ninth aspect of the present disclosure, and a content playback apparatus, the content recording apparatus and the content playback apparatus being connected to each other through a wireless transmission path. The content playback apparatus is provided with: a wireless transmitting and receiving unit for receiving encoded program content from the content recording apparatus; a decoding unit for decoding the encoded program content for playback; and a verifying unit for generating result information indicating whether or not the program content received from the content recording apparatus has been correctly played back on the content playback apparatus. The wireless transmitting and receiving unit of the content playback apparatus transmits the result information to the content recording apparatus.

A content transmission system according to the present disclosure can encode new program content at an optimal data rate, based on result information indicating that program content transmitted previously to a content playback apparatus has been correctly played back on the content playback apparatus.

According to the content transmission system according to the present disclosure, the data rate at which program content is encoded does not exceed the transmission rate of a wireless transmission path, thus preventing the necessity of re-encoding the program content. Therefore, it is possible to record program content, and simultaneously transmit the recorded program content to the content playback apparatus through the wireless transmission path, so that the content playback apparatus plays back the program content in real time.

1. A content recording apparatus connected to a content playback apparatus through a wireless transmission path, the content recording apparatus comprising:
an encoding unit for encoding program content at a data rate;
a program content storage for storing the encoded program content;
a wireless transmitting and receiving unit for transmitting the encoded program content to the content playback apparatus;
a data rate memory for storing the data rate at which the program content is encoded; and
a data rate setting unit for setting the data rate stored in the data rate memory, on the encoding unit,
wherein the wireless transmitting and receiving unit receives result information from the content playback apparatus, the result information indicating whether or not the program content transmitted to the content playback apparatus has been correctly played back on the content playback apparatus, and
wherein the data rate setting unit determines, based on the result information, a data rate at which the program content is encoded, and stores the data rate in the data rate memory.

2. The content recording apparatus as claimed in claim 1,
wherein when the data rate setting unit receives result information indicating that the program content has not been correctly played back, the data rate setting unit determines to decrease the data rate, and stores the decreased data rate in the data rate memory.

3. The content recording apparatus as claimed in claim 1,
wherein when the data rate setting unit receives result information indicating that the program content has been correctly played back, the data rate setting unit determines to increase the data rate, and stores the increased data rate in the data rate memory.

4. The content recording apparatus as claimed in claim 1,
wherein the data rate memory stores a plurality of data rates,
wherein the encoding unit encodes the program content at each of the plurality of data rates,
wherein the wireless transmitting and receiving unit transmits the plurality of pieces of program content encoded at the plurality of data rates, respectively, to the content playback apparatus, and receives pieces of result information from the content playback apparatus, each of the pieces of result information indicating whether or not each of the plurality of pieces of program content transmitted to the content playback apparatus has been correctly played back on the content playback apparatus, and
wherein the data rate setting unit stores the pieces of result information in the data rate memory, in association with the plurality of data rates, respectively.

5. The content recording apparatus as claimed in claim 4,
wherein the encoding unit encodes the program content at all those of the plurality of data rates that are associated with pieces of result information indicating that the program content has been correctly played back.

6. The content recording apparatus as claimed in claim 4,
wherein the encoding unit encodes the program content at the highest one of the plurality of data rates that is associated with a piece of result information indicating that the program content has been correctly played back.

7. The content recording apparatus as claimed in claim 4,
wherein when result information associated with any of the plurality of data rates is not stored in the data rate memory, the encoding unit encodes only a portion of the program content corresponding to a part of an entire duration of the program content.

8. The content recording apparatus as claimed in claim 1,
wherein, for each of at least one piece of program content having been correctly played back on the content playback apparatus, the data rate memory stores therein a data rate used to encode the program content, and attribute information uniquely identifying the program content, and
wherein when the data rate memory stores therein substantially same attribute information as attribute information of program content to be encoded, the data rate setting unit sets a data rate associated with the attribute information stored in the data rate memory, on the encoding unit.

9. The content recording apparatus as claimed in claim 8,
wherein the attribute information includes at least one of a name of the program content, and broadcast date and time of the program content.

10. A content recording method for a content recording apparatus connected to a content playback apparatus through a wireless transmission path, the content recording apparatus comprising an encoding unit, a program content storage, and a data rate memory, the content recording method including:
setting a data rate stored in the data rate memory, on the encoding unit;
encoding, by the encoding unit, program content at the set data rate;
storing the encoded program content in the program content storage;
wirelessly transmitting the encoded program content to the content playback apparatus;
wirelessly receiving result information from the content playback apparatus, the result information indicating whether or not the program content transmitted to the content playback apparatus has been correctly played back on the content playback apparatus; and
determining, based on the result information, a data rate at which the program content is encoded, and storing the data rate in the data rate memory.

11. The content recording method as claimed in claim 10,
wherein the storing includes determining to decrease the data rate, and storing the decreased data rate in the data rate memory, when receiving result information indicating that the program content has not been correctly played back.

12. The content recording method as claimed in claim 10,
wherein the storing includes determining to increase the data rate, and storing the increased data rate in the data rate memory, when receiving result information indicating that the program content has been correctly played back.

13. The content recording method as claimed in claim 10,
wherein the data rate memory stores therein a plurality of data rates, and
wherein the content recording method includes:
encoding, by the encoding unit, the program content at each of the plurality of data rates;
wirelessly transmitting the plurality of pieces of program content encoded at the plurality of data rates, respectively, to the content playback apparatus;
wirelessly receiving pieces of result information from the content playback apparatus, each of the pieces of result information indicating whether or not each of the plurality of pieces of program content transmitted to the content playback apparatus has been correctly played back on the content playback apparatus; and
storing the pieces of result information in the data rate memory, in association with the plurality of data rates, respectively.

14. The content recording method as claimed in claim 13, including encoding, by the encoding unit, the program content at all those of the plurality of data rates that are associated with pieces of result information indicating that the program content has been correctly played back.

15. The content recording method as claimed in claim 13, including encoding, by the encoding unit, the program content at the highest one of the plurality of data rates that is associated with a piece of result information indicating that the program content has been correctly played back.

16. The content recording method as claimed in claim 13, wherein the encoding includes encoding, by the encoding unit, only a portion of the program content corresponding to a part of an entire duration of the program content, when result information associated with any of the plurality of data rates is not stored in the data rate memory.

17. The content recording method as claimed in claim 10,
wherein, for each of at least one piece of program content having been correctly played back on the content playback apparatus, the data rate memory stores therein a data rate used to encode the program content, and attribute information uniquely identifying the program content, and
wherein the content recording method includes, when the data rate memory stores therein substantially same attribute information as attribute information of program content to be encoded, setting a data rate associated with the attribute information stored in the data rate memory, on the encoding unit.

18. The content recording method as claimed in claim 17,
wherein the attribute information includes at least one of a name the program content, and broadcast date and time of the program content.

19. A content transmission system comprising: a content recording apparatus and a content playback apparatus connected to each other through a wireless transmission path,
wherein the content recording apparatus comprises:
an encoding unit for encoding program content at a data rate;
a program content storage for storing the encoded program content;
a wireless transmitting and receiving unit for transmitting the encoded program content to the content playback apparatus;
a data rate memory for storing the data rate at which the program content is encoded; and
a data rate setting unit for setting the data rate stored in the data rate memory, on the encoding unit,
wherein the wireless transmitting and receiving unit of the content recording apparatus receives result information from the content playback apparatus, the result information indicating whether or not the program content transmitted to the content playback apparatus has been correctly played back on the content playback apparatus, and
wherein the data rate setting unit determines, based on the result information, a data rate at which the program content is encoded, and stores the data rate in the data rate memory, wherein the content playback apparatus comprises:
a wireless transmitting and receiving unit for receiving encoded program content from the content recording apparatus;
a decoding unit for decoding the encoded program content for playback; and
a verifying unit for generating result information indicating whether or not the program content received from the content recording apparatus has been correctly played back on the content playback apparatus, and
wherein the wireless transmitting and receiving unit of the content playback apparatus transmits the result information to the content recording apparatus.
